(19) United States
(12) Patent Application Publication
(10) Pub. No.: US 2019/0087786 A1
(43) Pub. Date: Mar. 21, 2019

(54) SYSTEM AND METHOD FOR AUTOMATED LEAD RETRIEVAL AND ATTENDANCE TRACKING

(71) Applicant: Expo Inc., Chicago, IL (US)

(72) Inventors: Brett Gough, South Barrington, IL (US); Doug Moring, Chicago, IL (US); Ciprian Petrini, Los Angeles, CA (US)

(21) Appl. No.: 16/135,429

(22) Filed: Sep. 19, 2018

Related U.S. Application Data
(60) Provisional application No. 62/560,494, filed on Sep. 19, 2017.
(60) Provisional application No. 62/579,701, filed on Oct. 31, 2017.

(51) Int. Cl. G06Q 10/10; G07C 1/12; H04L 29/08

(52) U.S. Cl. CPC G06Q 10/1095; H04L 67/306; G07C 1/12

(57) ABSTRACT

The present application discloses a system and method of online event management by using various computer implemented modules such as Registration Module, Event Module, Attendance Tracking Module and Lead Retrieval Module, all communicatively connected for seamless tracking and lead retrieval of conference attendees. More particularly, the present invention is related to a computer or machine implemented method and related system and method for carrying out an automated or machine-assisted event based lead retrieval and attendance tracking process for various events and conferences based on organization and business needs.

### CROSS REFERENCE TO RELATED APPLICATIONS

The present application claims priority from U.S. Provisional Application Ser. No. 62/560,494, filed Sep. 19, 2017 and U.S. Provisional Application Ser. No. 62/579,701, filed Oct. 31, 2017 all of which is herein incorporated by reference in its entirety.

### BACKGROUND OF THE INVENTION

The present disclosure generally relates to a system and method of online event management by using various computer implemented modules such as Registration Module, Event Module, Attendance Tracking Module and Lead Retrieval Module, all communicatively connected for seamless tracking and lead retrieval of conference attendees. More particularly, the present invention is related to a computer or machine implemented method and related system and method for carrying out an automated or machine-assisted event based lead retrieval and attendance tracking process for various events and conferences based on organization and business needs.

Conferences and events require an efficient management of registration of attendees with a simplified device agnostic process to obtain ancillary qualifying data. This data further allows access to registration specific content and benefits.

Previously, the process of managing conference attendees especially with lead retrieval and attendance tracking was performed through physical transfer of business cards and note taking. However, with the advancement of computing technology such management of event looks highly inefficient and cumbersome.

Accordingly, there has been identified a need for an improved system and method for automated or machine-assisted online event management by using various computer implemented modules such as Registration Module, Event Module, Attendance Tracking Module and Lead Retrieval Module, all communicatively connected for seamless tracking and lead retrieval of conference attendees.

### SUMMARY OF THE INVENTION

Described herein are embodiments of systems and methods for enabling event based attendance tracking and lead retrieval for conference attendees. These systems may be implemented using a variety of hardware and may interact with conference and event organizers, their vendors and other applicable and/or necessary parties to improve their processes, capture available information and revenue and otherwise overcome the limitations, shortcomings and disadvantages of known systems and methods. Software operates as a set of instructions running in executable memory of a processor residing on a computing device. It is to be recognized by one of skill in the art that the terms “software,” “app,” “module,” “routine,” or “sub-routine” may be used interchangeably in this specification to describe a software or component parts thereof. In some embodiments of the present invention, each described module or routine/sub-routine is a component part of a larger set of software instructions while in other embodiments each described module or routine/sub-routine act as independent software applications. It is also to be recognized by one of skill in the art that the term “database” as used may describe a single specific database, or a sub-section of a larger database.

In a first embodiment the system comprises a local computer or a backend cloud server and networked devices configured with a graphical user interface (GUI) and plurality of communicatively coupled software modules configured to register users and collect and store pertinent registration data, event data, attendance data, and lead data. Networked devices may include but are not limited to cell phones, handheld devices, different portable tablets, or portable computers, or additional computers.

In one aspect of system, the system includes a Registration Module (RM) that is available on or accessible through the computer or networked device. The RM is a data collection module configured to collect information regarding the event, including, but not limited to, attendee profile, exhibitor profile, and session details regarding the particular event or exhibition appropriately and store that information in an accessible RM database.

In an additional aspect of the system, the system includes an Event Module (EM) that is available on or accessible through a computer or networked device. The EM is a data collection module configured to collect information regarding the event and store the information in an accessible EM database.

In yet another aspect of the system, the system includes a Session Tracking Module (STM) that is available on or accessible through a computer or networked device. The STM is a data collection module configured to collect information regarding a particular session or presentation of the event and store the information in an accessible STM database.

In yet another embodiment of the system, the system includes an Attendance Tracking Module (ATM) that is available on or accessible through a computer or networked device. The ATM is a data collection module configured to collect information attendance of a session or presentation of the event and store the information in an accessible ATM database.

In another embodiment of the system, the system includes a Lead Retrieval Module (LRM) that is available on or accessible through a computer or networked device. The LRM is a data collection module configured to allow attendees and exhibitors to collect each other's respective data or allow exhibitors access to attendee data to target specific leads.

### BRIEF DESCRIPTION OF THE DRAWINGS

The following disclosure as a whole may be best understood by reference to the provided detailed description when read in conjunction with the accompanying drawings, drawing descriptions, abstract, background, field of the disclosure, and associated headings. Identical reference numerals, when found on different figures, identify the same elements or functionally equivalent elements. The elements listed in the abstract are not referenced but nevertheless refer by association to the elements of the detailed description and associated disclosure.

FIG. 1 is an illustration of a hardware system wherein a system and method in accordance with the present invention can be implemented.

FIG. 2 is an illustration of a flow chart wherein a system and method in accordance with the present invention can be implemented.

FIG. 3 is a screen shot illustrating a “Registration” page of the Registration Module of an exemplary application for lead retrieval and attendance tracking system.

FIG. 4 is a screen shot illustrating a page or an app on a handheld device within the Event Module of an exemplary application for lead retrieval and attendance tracking system.

FIG. 5 is a screen shot illustrating a “Lead Retrieval” page or app of the Lead Retrieval Module on a handheld device of an exemplary application for lead retrieval and attendance tracking system.

FIG. 6 is a screen shot illustrating a “Sessions Tracking” page or app on a handheld device for easy tracking of sessions during conferences and events of an exemplary application for lead retrieval and attendance tracking system.

FIG. 7 is a screen shot illustrating standard fields of information that attendees to a conference will need to provide as part of the Registration Module of an exemplary application for lead retrieval and attendance tracking system.

FIG. 8 is a screen shot illustrating standard fields of information that attendees to a conference will need to provide as part of the Registration Module page of an exemplary application for lead retrieval and attendance tracking system.

FIG. 9 is a screen shot illustrating the registration form posted on the customer side and which can also integrate customer's Google tracking code to signal the marketing channel from which a customer learned about the event as well as make real-time updates without any code changes to the Registration form based on new information of an exemplary application for lead retrieval and attendance tracking system.

FIG. 10 is a screen shot illustrating the payment and refund system of an exemplary application for lead retrieval and attendance tracking system.

FIGS. 11-14 are screen shots illustrating the attendee app that is instantly accessible during event registration providing session feedback, list of speakers, list of exhibitors and their locations in the conference venue, vendor materials, social feedback, travel information and other conference related details of an exemplary application for lead retrieval and attendance tracking system.

FIG. 15 is screen shot illustrating the mobile app to manage leads which can be further incorporated within a customer relationship management (CRM) system of an exemplary application for lead retrieval and attendance tracking system.

FIGS. 16-17 are screen shots illustrating the session tracking details in a web based format as well as in a mobile app format of an exemplary application for lead retrieval and attendance tracking system.

### DETAILED DESCRIPTION OF THE PREFERRED EMBODIMENTS

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

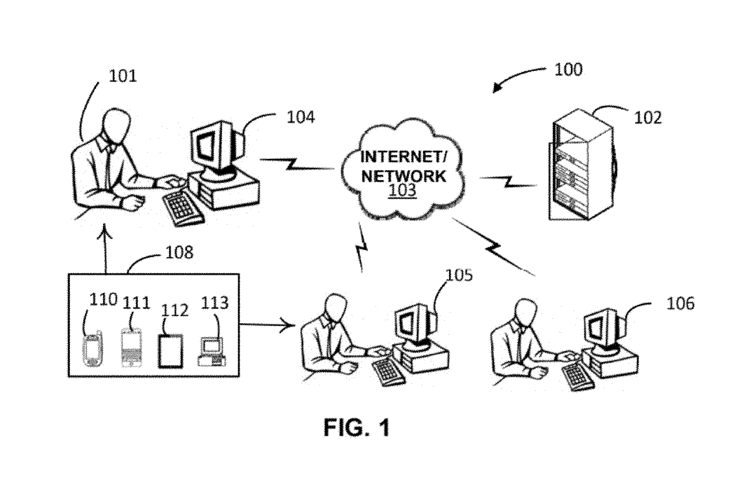

To fully enable the software and its functionality described herein, the present disclosure begins with a summary of how computers may be used, either alone or in a networked configuration. FIG. 1 illustrates a hardware configuration 100 wherein a system and method for managing an event online is implemented by managing attendance tracking and lead retrieval for conference attendees used by different users 101 and connected over a network 103. The network 103 is suitable for connecting the one or more computers 104, 105 and 106, or mobile devices 110, 111, 112 and 113 and may comprise one or more networks such as a local area network (LAN), a wide area network (WAN) such as the Internet, telephone networks, including telephone networks with dedicated communication links and/or wireless links, and wireless networks. In the illustrative example shown in FIG. 1, the network 103 is the Internet. Each of the one or computers 104, 105 and 106, or mobile devices 110, 111, 112 and 113 is connected to the network 103 via a suitable communication link, such as a dedicated communication line or a wireless communication link.

In an embodiment, the system may be implemented using software that is either local or operating from a remote server such as a web server or cloud server over the Internet. Further, with the rapid growth of Internet technology and portable wireless technology, other computing devices, such as, but not limited to, cell phones, handheld devices, different portable tablets, or portable computers, may be used in place of or in addition to the one or more computers.

Each of the one or more computers 104, 105 and 106, comprises a central processing unit (CPU), an input/output (I/O) unit, a display device communicatively coupled to the I/O unit, a storage device, and a memory. Each of the one or more computers 104, 105 and 106, or mobile devices 110, 111, 112 and 113 may further comprise one or more standard input devices such as a keyboard, a mouse, speech processing means, or a touchscreen.

The memory includes a Graphical User Interface (GUI) that is used to convey information to and receive information from a user of the one or more computers 104, 105 and 106, or mobile devices 110, 111, 112 and 113 via the display device and I/O unit as described herein. The GUI includes any user interface capable of being displayed on a display device including, but not limited to, a web page, a display panel in an executable program, or any other interface capable of being displayed on the one or more computers 104, 105 and 106, or mobile devices' 110, 111, 112 and 113 respective display devices.

As will be recognized by one of skill in the art, each of the cell phones 110, hand-held devices 111, different portable tablets 112, or computers 113 may be configured similarly to the one or more computers 104, 105 and 106, or mobile devices 110, 111, 112 and 113, taking into account the various design considerations of these respective devices.

The GUI may be transmitted to the one or more computers 104, 105 and 106, or mobile devices 110, 111, 112 and 113 or other devices via the network 103. In one embodiment in accordance with the present invention, the GUI is displayed using commercially available hypertext markup language (“HTML”) viewing software such as, but not limited to, MICROSOFT INTERNET EXPLORER, GOOGLE CHROME, APPLE SAFARI, OR MOZILLA FIREFOX, or any other commercially available HTML viewing software.

The GUI may reside on a remote server or within the local hardware of the device. The remote server 102 may comprise one or more separate servers or may be a web server. The remote server 102 may comprise a CPU, memory, and separate storage device and be communicatively coupled to the network 103. The remote server 102 may contain an information storage device that may be a rational database, such as MICROSOFT' s SQL or any other database.

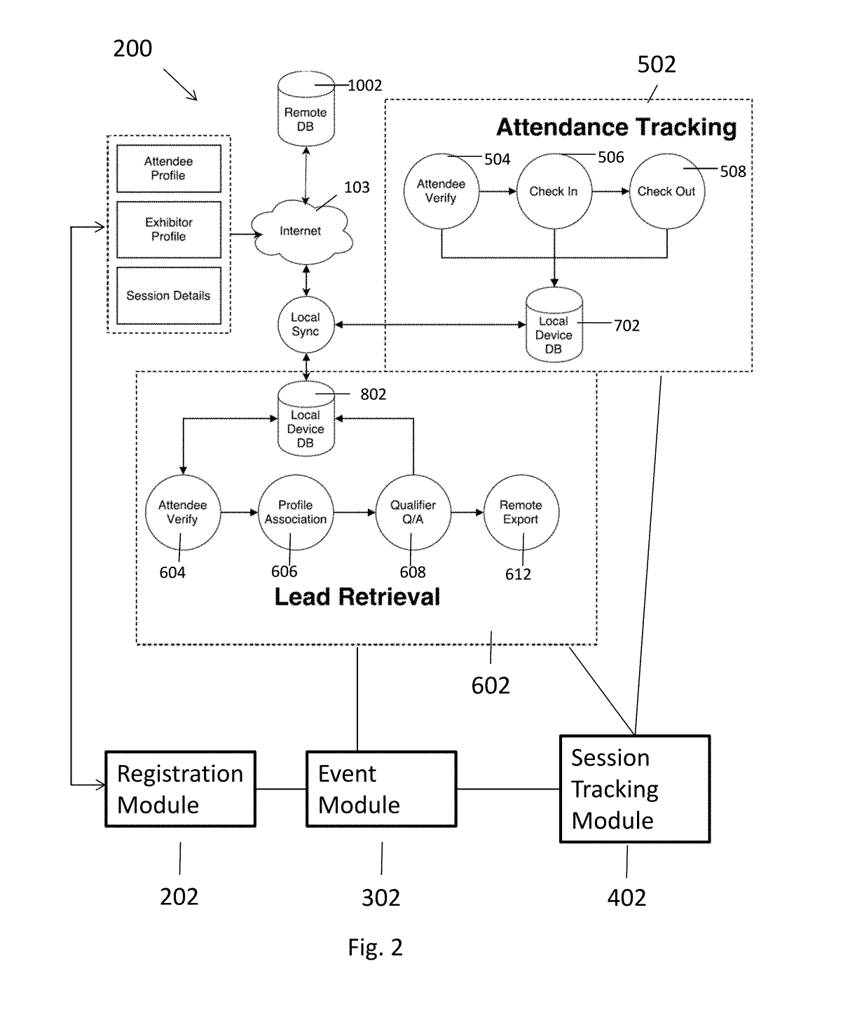

In a first embodiment the system 200, as illustrated in FIG. 2, the system 200 comprises a local computer or a backend cloud server configured with a Registration Module 202 configured to collet registration data, an Event Module 302 configured to collect event data, an Attendance Tracking Module 502 configured to collect attendance data, a Lead Retrieval Module 602 configured to collect lead data, and a Session Tracking Module 402 configured to collect session data. Each respective module and subsequent collected data may be communicatively connected to share data through the system 200.

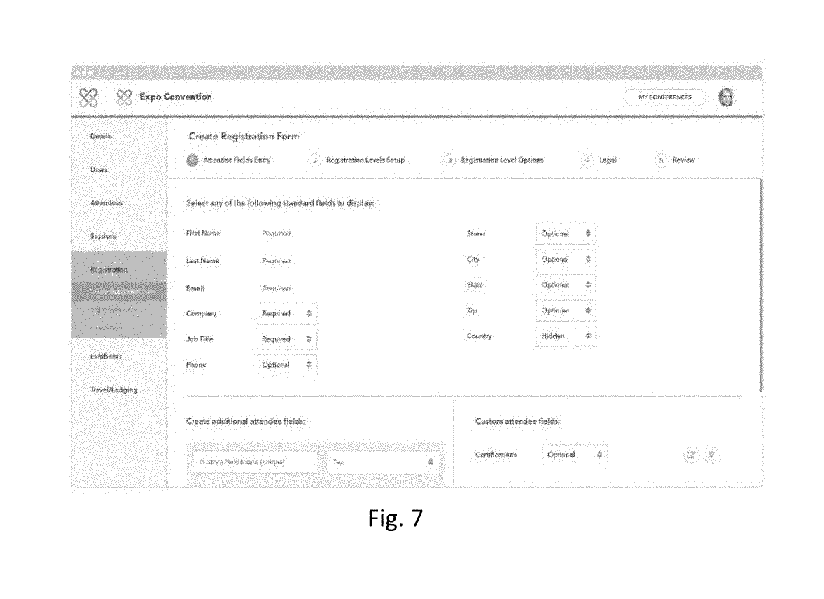

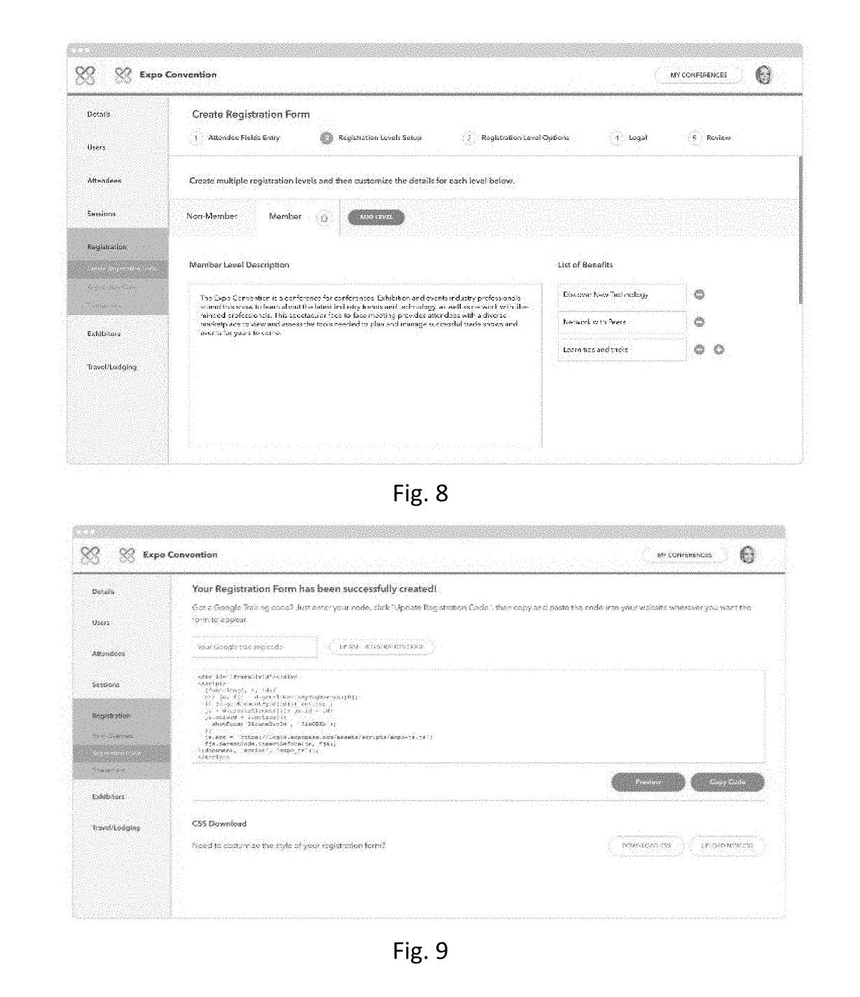

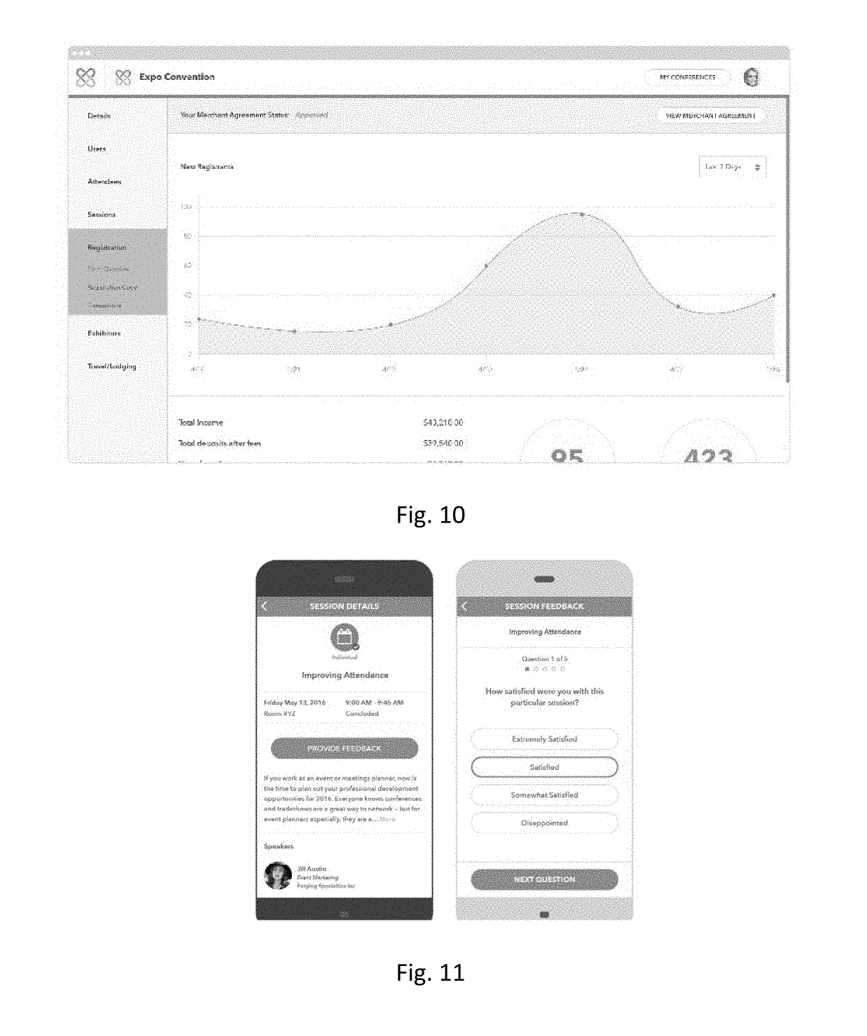

As illustrated in FIG. 2, the system 200 includes a Registration Module (RM) 202 that is available on or accessible through a computer or networked device. The RM 202 is a data collection module configured to collect registration data regarding the event, including, but not limited to, attendee profiles, exhibitor profiles, and session details regarding the particular event or exhibition appropriately and store that information in an accessible RM database. As shown in FIGS. 7-9, an event organizer, through the GUI, may several have access to pre-determined customized field for consideration or have the opportunity to customize information according to specific business needs. The organizer may collect data or enter data including but not limited to specific requirements in terms of sessions, to paid attendance levels, single or multi-use of promotional codes or any other items related to attending a conference or participating in an event. The RM 202 may also be configured to validate membership for each event and conference by cross-checking registrant data with a previously existing membership data. Additionally, as shown in RM 202 GUI examples in FIG. 10, the RM 202 may be configured as a payment module provisioned for collection of funds through rolling deposits and to issue fund refund directly to customers, if required.

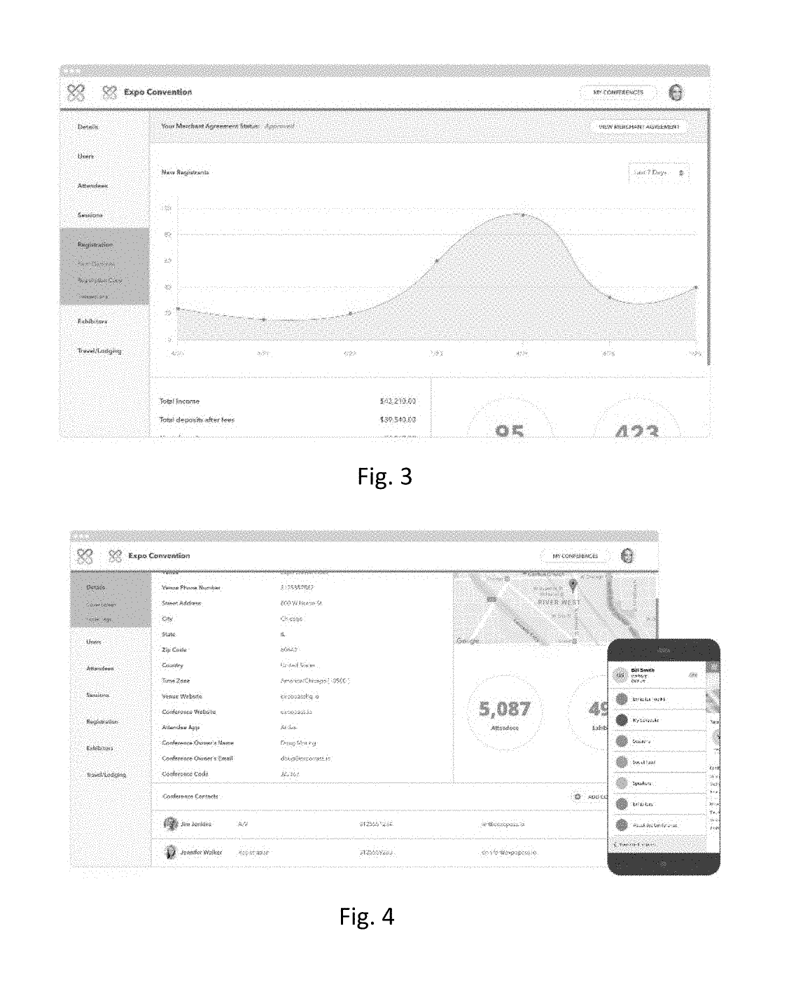

In operation, the RM 202 is accessed through the system GUI as shown in FIGS. 3-4 and is configured to prompt a user such as a registrar, attendee, or exhibitor to enter identifying data and upload the identifying data into the RM database. In some embodiments the RM 202 is further configured to analyze the identifying data subscribe the user to specific content pertinent to the event. The data obtained through the RM 202 may be made available to other modules within the system 200. In some embodiments, the RM database may be accessed by the Attendance Tracking Module 502 for tracking attendees' movement in and out of sessions. In other embodiments, the data obtained through the RM 202 made available to the Lead Retrieval Module 602 so that an exhibitor may learn more about an attendee by seeing the information provided by the attendee.

In additional embodiments of the RM 202, the RM 202 is configured as an API to be integrated on an end user's website and allow access to the data collection module accordingly. In other embodiments, the RM 202 is configured to integrate data from third party API's to integrate user data such as a customer's GOOGLE tracking code (or similar identifying code including but not limited to FACEBOOK ID, LINKEDIN). These embodiments allow real-time updates without any code changes to the Registration form based on new information.

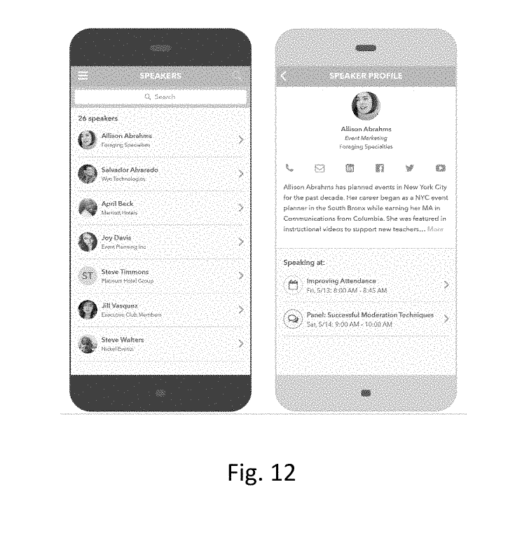

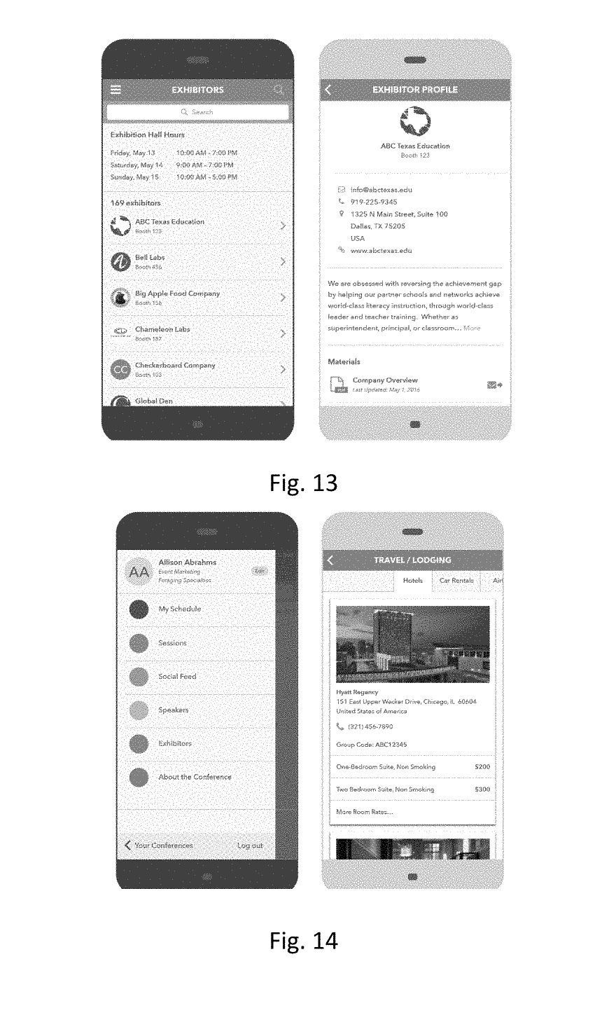

In an additional embodiment of the present invention, the system includes an Event Module (EM) 302 that is available on or accessible through a computer or networked device. The EM 302 is a data collection module configured to collect event data regarding the event and store the information in an accessible EM database. In operation, an event organizer may access and execute the EM 302 during or before an event and be prompted through the GUI to enter event identifying data including, but not limited to, presentation schedules, presenter and exhibitor information, venue information and environment. In some embodiments, the Lead Retrieval Module 602 and Attendance Tracking Module 502 are part of or are additional sub-routines of the EM 302. In these embodiments, all these modules work cohesively as one unit to share data between them. In additional aspects of the EM 302, the EM 302 may be configured to display EM data through the GUI on a computer or networked device to registered users as shown in FIGS. 11-14. The EM data presented may include session feedback, list of speakers, list of exhibitors and their locations in the conference venue, vendor materials, social feedback, travel information and other conference related details of an exemplary application for lead retrieval and attendance tracking system.

In an embodiment of the present invention, the system 200 includes a Session Tracking Module (STM) 402 that is available on or accessible through a computer or networked device. The STM 402 is a data collection module configured to collect session tracking data regarding a particular session or presentation of the event and store the information in an accessible STM database. As shown in FIG. 6, the STM 402 is additionally configured to display session tracking data such as scheduling, speaker information and event type through the GUI to registered attendees. In operation, the event organizer may access and execute the STM 402 during the session or presentation and be prompted through the GUI to collect active session data including but not limited to attendees and exhibitors checking in and out of the event or session, audio/visual recordings of the session, transcriptions of the session, and active or passive tagging of exhibitor/presenter interactions and attendees may access and execute the STM 402 through the GUI to access scheduling and uploaded materials. The data stored in the STM database may be used in many ways including but not limited to presenters and attendees to follow up on active conversations and event organizers looking to see what demographic of people were interested in the event and how long the attendees stayed.

In yet another embodiment of the present invention, the system 200 includes an Attendee Tracking Module (ATM) 502 that is available on or accessible through a computer or networked device. The ATM 502 is a data collection module configured to collect attendance data regarding attendance of a session or presentation of the event and store the information in an accessible ATM database 702. The ATM 502 may include additional modules or subroutines such as the Attendee Verification Module (AVM-ATM) 504, Attendee Check In Module (ACIM) 506 and Attendee Check Out Module (ACOM) 508. In some embodiments, the ATM 502 is connected via a network to a local device, such as a barcode/QR code scanner, camera, or other input device, to execute the AVM 504. The AVM 504 uses the local device to identify a pre-configured hash or anonymous data within a QR code, RFID, or similar unique identifying device to look up the individual within the RM database. Upon finding a positive match, the ACIM 506 proceeds with changing the status of the user within the ATM database or linked RM database to reflect attendance. In some embodiments the ACIM 506 additionally provides a time stamp to the database as well. Upon leaving the event, in some embodiments, the ATM 502 is connected via a network to a local device, such as a barcode/QR code scanner, camera, or other input device, to execute the AVM 504 and initiate the ACOM 508. Upon finding a positive match, the ACOM 508 proceeds with changing the status of the user within the ATM database or linked RM database to reflect that the user has left the event. In some embodiments the ACOM 508 additionally provides a time stamp to the database as well.

In additional iterations, the ATM 502 may include an additional subroutine configured to communicate with the RM database to determine if the attendee is seeking credit for attendance from a regulatory agency for continued education. In these embodiments, if the ATM 502 determines that credit is required, the module may be preconfigured to electronically notify the regulatory agency of attendance, the event type, and the duration of the event.

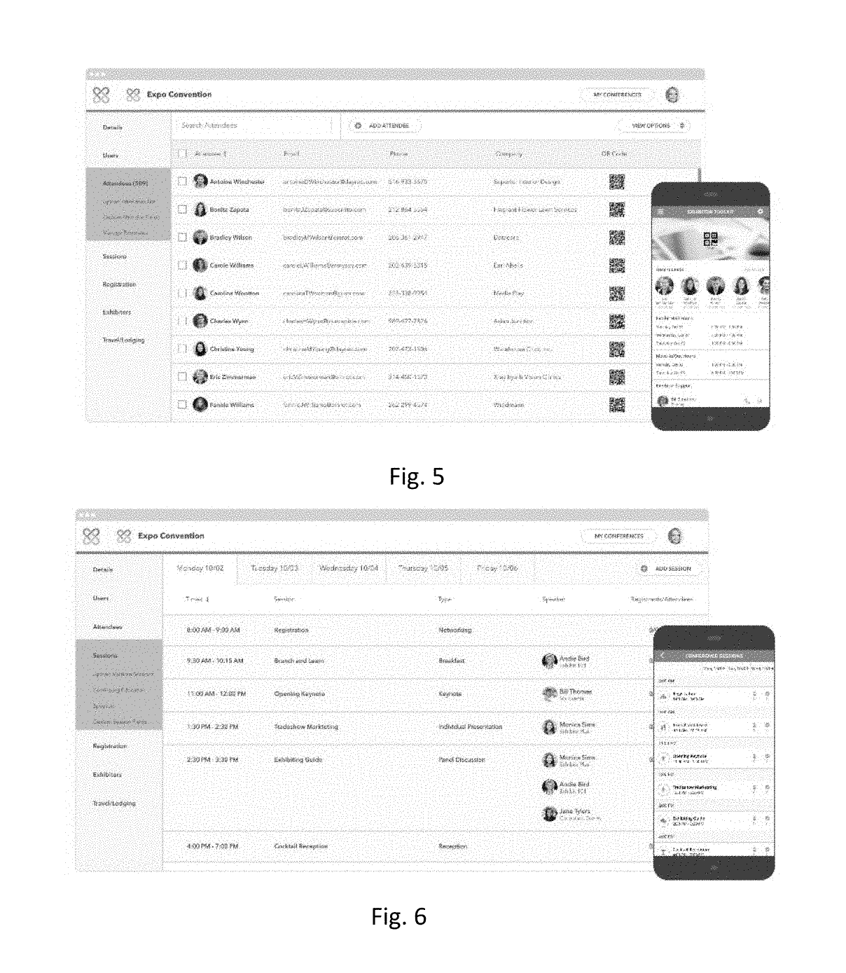

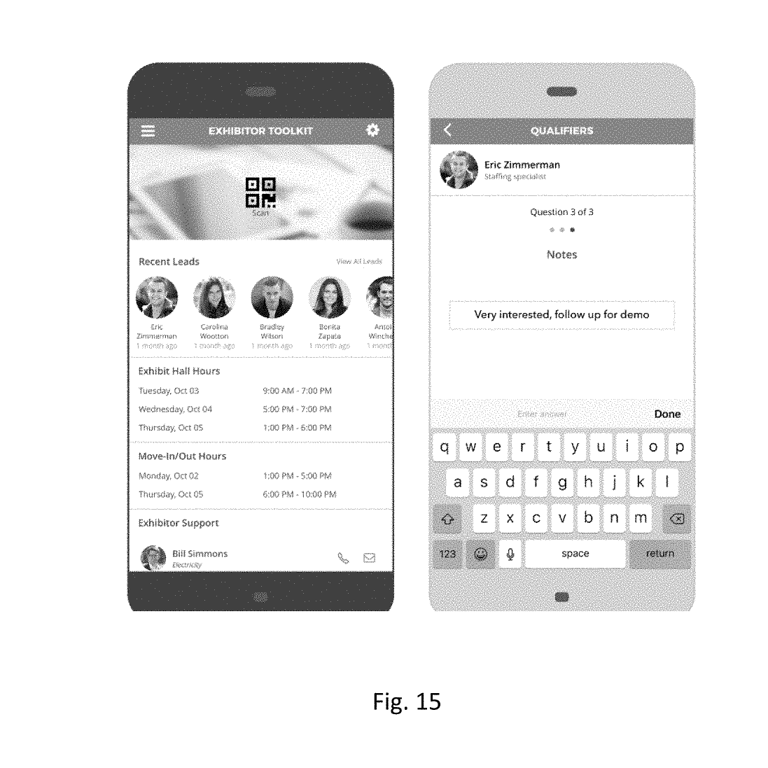

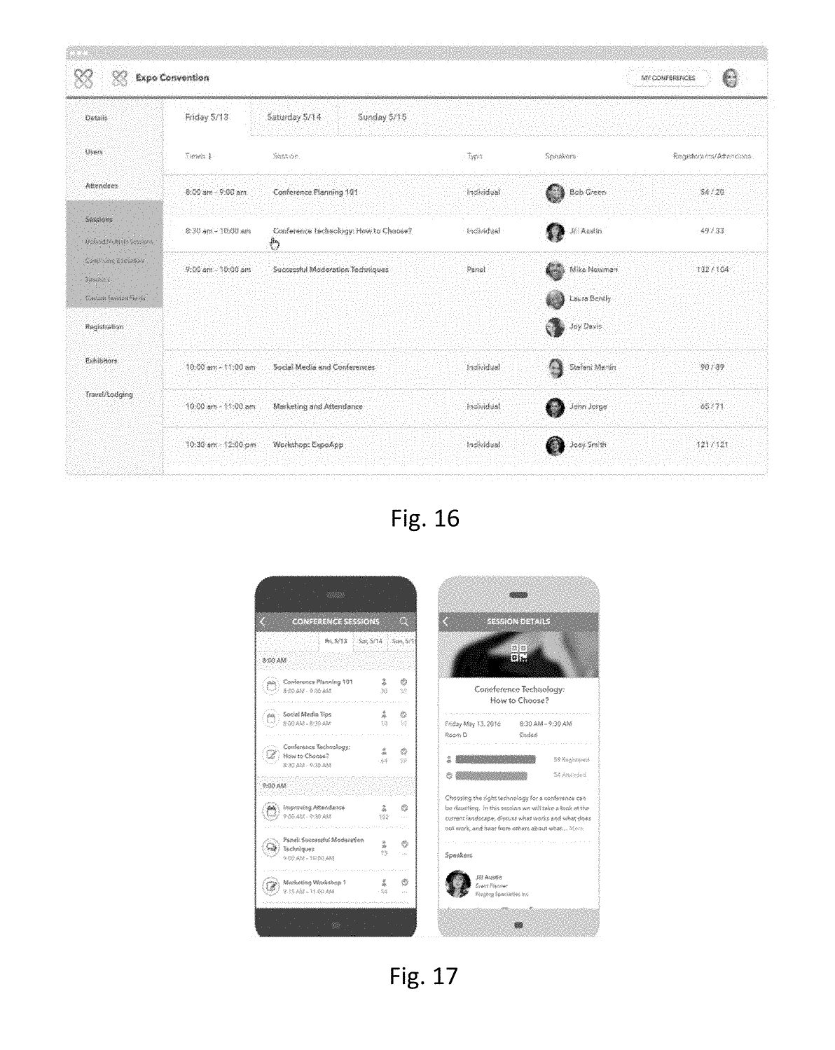

In another aspect of the system 200, the system 200 includes a Lead Retrieval Module (LRM) 602 that is available on or accessible through a computer or networked device. The LRM is a data collection module configured to allow attendees and exhibitors to collect each other's respective data or allow exhibitors access to attendee data to target specific leads and store the data in an LRM database 802. The LRM 602 may include additional modules or subroutines such as the Attendee Verification Module (AVM-LRM) 604, the Profile Associator Module (PAM) 606, the Attendee Qualifier Module (AQM) 608, and the Remote Export Module (REM) 612. Similar to the ATM 502, the LRM 602 is connected via a network to a local device, such as a barcode/QR code scanner, camera, or other input device, (110, 111, 112 and 113) to execute the AVM 604. The AVM 604 uses the local device to identify a pre-configured hash or anonymous data within a QR code, RFID, or similar unique identifying device to look up the individual within the RM database. Upon finding a positive match, the PAM 606 is initiated and grants access to the profile data of the subject being recorded and the subject gets stored as a “lead” for the individual scanning in the LRM database 802. In some embodiments the LRM 602 initiates the AQM 608 which is configured to collect lead data including but not limited to lead notes, photographs and recordings of the exhibitor attendee interaction through the GUI store the lead data in the LRM database 802. In some embodiments, the LRM 602 may prompt a user through the GUI to query identifying data, including but not limited to industry, company, geographic location, about potential leads, the user inputs the data, and the LRM 602 executes a search routine through the RM database and returns results that relevant to the query. The user may then add the returned results to as potential leads who may be interested in their particular services. In order to extract useful lead data, the REM 612 is configured to be executed through the GUI and export the lead data out of the system into standard word processing and database formats. In some embodiments, the REM 612 is additionally configured to send the external reports to a local device, email address, messaging service, or cloud server. GUI representations of the LRM 402 are shown in FIGS. 5 and 15-17.

In an embodiment, the system allows an attendee to register through the website or manually by the organizer of the event. An attendee once added to the database is assigned a Quick-Response (QR) code. That attendee data may then be made available for sync to a local device, after which an attendee may be identified and checked into and out of a session for purposes of Attendance Tracking. Additionally, that attendee may be identified and their data transferred to an exhibitor.

In an embodiment, an organizer of an event onsite can print a badge with the assigned QR code on it and after which exhibitors or organizers may scan that badge for either a lead retrieval function or scanning into and out of sessions.

The systems and methods of the present invention may be embodied in various forms, including, for example, a data processor, such as the computer that also includes a database. Moreover, the above-noted features and other aspects and principles of the instant disclosure may be implemented in various environments. Such environments and related applications may be specially constructed for performing the various processes and operations of the instant disclosure, or they may include a general-purpose computer or computing platform selectively activated or reconfigured by code to provide the necessary functionality.

Whereas particular aspects of this invention have been described above for purposes of illustration, it will be evident to those skilled in the art that numerous variations of the details of the present invention may be made without departing from the invention.

Network and communication between the various modules may include, alone or in any suitable combination, a telephony-based network, a local area network (LAN), a wide area network (WAN), a dedicated intranet, the Internet or World Wide Web, a wireless network, a bus, or a backplane. Further, any suitable combination of wired and/or wireless components and systems may be incorporated into the network. Moreover, the network may be embodied as bi-directional links or as unidirectional links.

The processes disclosed herein are not inherently related to any particular computer or other apparatus, and may be implemented by a suitable combination of hardware, software, and/or firmware. For example, various general-purpose machines may be used with programs written in accordance with the instant teachings, or it may be more convenient to construct a specialized apparatus or system to perform the required methods and techniques.

Apparatus, systems and methods consistent with the instant disclosure also include computer-readable media (or memory) that include program instructions or code for performing various processing device-implemented operations based on the methods and processes described herein. The media and program instructions may be those specially designed and constructed for the purposes of the instant disclosure, or they may be of the kind well known and available to those having skill in the computer software arts. Examples of program instructions include, for example, machine code, such as produced by a compiler, and files containing a high-level code that can be executed by the computer using an interpreter.

While particular preferred embodiments have been shown and described, it is to be understood that the foregoing description is exemplary and explanatory only and is not restrictive of the instant disclosure. Those skilled in the art will appreciate that changes and additions may be made without departing from the instant teachings. For example, the teachings of the instant disclosure may be directed to various combinations and sub-combinations of the disclosed features and/or combinations and sub-combinations of several further features described herein. It is therefore contemplated that any and all modifications, variations or equivalents of the above-described teachings fall within the scope of the basic underlying principles disclosed above and claimed herein.

1. An event management system comprising:
a backend networked server configured to execute a plurality of event management software modules and having a front end graphical user interface accessible by a networked device;
a registration module configured to collect registration data through preset or customizable data entry fields accessible through the graphical user interface and store the registration data in a registration module database;
an event module configured to collect event data through preset or customizable data entry fields accessible through the graphical user interface and store the event data in an event module database;
an attendance tracking module configured to collect event attendance data through the graphical user interface and store attendance data in an attendance module database;
a lead retrieval module configured to collect lead data through the graphical user interface and store the lead data in a lead retrieval module database; and
wherein each module of the plurality of software modules is communicatively coupled through the backend networked server to share collected data.

2. The event management system of claim 1 wherein the registration module database, event module database, attendance module database, and lead retrieval module database, are sub-databases of a system database.

3. The event management system of claim 1 wherein the registration module is further configured to collect registrant profiles from the registration module database.

4. The event management system of claim 3 wherein the registration module is further configured to validate membership by cross-checking the registrant profiles with a prepopulated membership database.

5. The event management system of claim 3 wherein the registration module is further configured to analyze registrant profiles and subscribe the registrant profiles to event content related to data collected in the registrant profiles.

6. The event management system of claim 1 wherein the registration module is configured as a payment module configured to collect electronic payment data through the graphical user interface and process the electronic payment data through an electronic payment service provider.

7. The event management system of claim 1 wherein the event module is further configured to collect presentation schedules, presenter and exhibitor information, venue information and environment information and configured to display the collected event data to a registrant through the graphical user interface.

8. The event management system of claim 1 wherein the attendance tracking module is further configured to collect attendance data through a check-in routine whereby the registrant accesses the graphical user interface of the attendance tracking module sets attendance as present or wherein the attendance tracking module is further configured to collect attendance data through a local networked device configured to detect a registrant's unique identifier code upon entrance to the event and set the registrant status as present and validate registrants attendance.

9. The event management system of claim 8 wherein the local networked device comprises a QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan.

10. The event management system of claim 8 wherein the attendance tracking module analyzes the registration module database to verify whether the attendee is seeking credit for attendance from a regulatory agency for continued education and is further configured to electronically notify the regulatory agency for continued education of completion of the course.

11. The event management system of claim 8 wherein the attendance tracking module is further configured to collect attendance data through a check-out routine whereby the registrant accesses the graphical user interface of the attendance tracking module sets attendance as checked-out or wherein the attendance tracking module is further configured to collect attendance data through a local networked device configured to detect a registrant's unique identifier code upon exiting the event and set the registrant status as checked-out and validate registrants attendance.

12. The event management system of claim 11 wherein the local networked device comprises a QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan.

13. The event management system of claim 1 wherein the lead retrieval module is further configured to collect lead retrieval data through a networked device configured to detect a registrant's unique identifier code, access the registration module database and save the registrants profile into an individual user's lead retrieval database.

14. The event management system of claim 13 wherein the local networked device comprises a QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan.

15. The event management system of claim 1 wherein the lead retrieval module is configured to prompt a registrant through the graphical user interface to query the registration module database for industry related leads and add returned registrant profiles as potential leads to the registrant's lead retrieval database.

16. The event management system of claim 1 further comprises a session tracking module wherein the session tracking module is further configured to collect active session data including but not limited to attendees and exhibitors checking in and out of the event or session, audio/visual recordings of the session, transcriptions of the session, and active or passive tagging of exhibitor/presenter interactions and attendees may access and allow access to the session tracking module database to the registrant through the graphical user interface

17. A method of tracking leads at an event comprising the steps of:
accessing a backend networked server configured to execute a plurality of event management software modules and having a front end graphical user interface accessible by a networked device wherein the plurality of event management software modules comprises a registration module configured to collect registration data through preset or customizable data entry fields accessible through the graphical user interface and store the registration data in a registration module database, an event module configured to collect event data through preset or customizable data entry fields accessible through the graphical user interface and store the event data in an event module database, a lead retrieval module configured to collect lead data through the graphical user interface and store the lead data in a lead retrieval module database;
activating the lead retrieval module through the graphical user interface of the local networked device;
acquiring a registrant's unique identifier code through the local networked device;
querying the registration module database for the registrant's unique identifier code and retrieving a registrant's profile from the registration module database; and
storing the registrant's profile in an individual's lead retrieval database.

18. The method of claim 17 wherein the local networked device comprises a QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan.

19. A method of tracking attendance at an event comprising the steps of:
accessing a backend networked server configured to execute a plurality of event management software modules and having a front end graphical user interface accessible by a networked device wherein the plurality of event management software modules comprises a registration module configured to collect registration data through preset or customizable data entry fields accessible through the graphical user interface and store the registration data in a registration module database, an event module configured to collect event data through preset or customizable data entry fields accessible through the graphical user interface and store the event data in an event module database, an attendance tracking module configured to collect lead data through the graphical user interface and store the attendance data in an attendance tracking module database;
activating the attendance tracking module through the graphical user interface of the local networked device;
acquiring a registrant's unique identifier code through the local networked device upon a registrant's entrance to the event;
querying the registration module database for the registrant's unique identifier code and validating a registrant's profile from the registration module database;
setting a registrant's attendance status in the attendance tracking module database;
acquiring a registrant's unique identifier code through the local networked device upon a registrant's exit of the event; and
setting a registrant's attendance status in the attendance tracking module database.

20. The method of claim 19 wherein the local networked device comprises a QR scanner, barcode scanner, RFID reader, camera or fingerprint reader and the registrant's unique identifier code comprises a pre-configured hash or anonymous data within a QR code, bar code, RFID chip, or the registrant's facial image or fingerprint scan.
